(19) United States
(12) Patent Application Publication
(10) Pub. No.: US 2010/0165078 A1
(43) Pub. Date: Jul. 1, 2010

(54) IMAGE COMPRESSION USING CHECKERBOARD MOSAIC FOR LUMINANCE AND CHROMINANCE COLOR SPACE IMAGES

(75) Inventors: Nicholas ROUTHIER, Candiac (CA); Jonathan LAVOIE, Pierrefonds (CA)

Correspondence Address: Anglehart et al., Suite 258, 393 St-Jacques, Montreal, QC, H2Y 1N9, CA

(73) Assignee: SENSIO TECHNOLOGIES INC., Montreal (CA)

(21) Appl. No.: 12/346,769

(22) Filed: Dec. 30, 2008

(51) Int. Cl. H04N 13/00; H04N 7/12

(52) U.S. Cl. 348/43; 375/240.01; 375/E07.076; 348/E13.001

(57) ABSTRACT

Image artefacts appearing when a checkerboard pattern spatial compression is applied to luminance-chrominance color space images having subsampled chroma data, such as YCbCr, is avoided by using a different checkerboard pattern for the luminance pixels than the pattern used for the chrominance pixels.

### TECHNICAL FIELD

This invention relates to spatial image compression involving removing pixels according to a checkerboard pattern.

### BACKGROUND

Image compression is important to reduce data storage volume and bandwidth requirements for image transmission.

It is known to use a quincunx or checkerboard pixel decimation pattern in video compression. In commonly assigned US patent application publication 2003/0223499, stereoscopic image pairs of a stereoscopic video are compressed by removing pixels in a checkerboard pattern and then collapsing the checkerboard pattern of pixels horizontally. The two horizontally collapsed images are then placed in a side-by-side arrangement within a single standard image frame, then subjected to conventional image compression (ex.: MPEG2). The decompressed standard image frame is then expanded into the checkerboard pattern and the missing pixels are spatially interpolated.

### SUMMARY

It has been discovered that image artefacts appearing when a checkerboard pattern spatial compression is applied to luminance-chrominance color space images, such as YCbCr, can be avoided if the checkerboard pattern used for the luminance pixels is different than the pattern used for the chrominance pixels. Such images are encoded with full spatial resolution of pixels for the luminance channel, while chominance pixels, namely blue Cb and red Cr, are encoded for odd pixels. This is called 4:2:2 encoding, and it has been found that the human eye does not perceive any significant loss of color resolution when full resolution is maintained in the luminance channel, while half resolution is used in the color or chroma channels. The even color components of pixels of a YCbCr source image are either simply repeated from the preceding odd pixels or interpolated from neighboring odd pixels for the purposes of generating a complete display-ready image. When using the same checkerboard pattern as for the luminance pixels, the chroma pixels retained by the pattern are sometimes interpolated or repeated pixels, and not original source image pixels. This creates a visible artefact when the spatially compressed checkerboard pattern of pixels is used to regenerate a full image. The different pattern for chroma pixels is a pattern, preferably again a checkerboard pattern, of original pixels, e.g. odd pixels, and not interpolated or repeated pixels.

### BRIEF DESCRIPTION OF THE DRAWINGS

The invention will be better understood by way of the following detailed description of embodiments of the invention with reference to the appended drawings, in which:

FIG. 1A is an illustration of full resolution luminance pixels of an image block according to the prior art.

FIG. 1B shows the image block of FIG. 1A with checkerboard pixel decimation.

FIG. 1C shows interpolated values of decimated pixels of FIG. 1B.

FIG. 2A is an illustration of an image block of subsampled chroma pixels, for example from a 4:2:2 image according to the prior art.

FIG. 2B shows the image block of FIG. 2A interpolated to full resolution.

FIG. 2C shows the image block of FIG. 2B decimated using the same checkerboard pattern as for the luminance pixels, in accordance with the prior art.

FIG. 2D shows the image block of FIG. 2C decimated to return to chroma subsampling, namely the 4:2:2 format, in accordance with the prior art.

FIG. 2E shows the image block of FIG. 2D with pixel interpolation according to a 4:2:2 to 4:4:4 conversion to yield a checkerboard pixel pattern.

FIG. 2F shows the full restoration of the chroma pixels from the pixels contained in FIG. 2E.

FIG. 2G shows the image block with the original chroma subsampling pixel pattern with those pixels not present in the checkerboard pattern of FIG. 2E interpolated from the pixels in FIG. 2E, and the pixels having an error with respect to the source of FIG. 2A shown with hatching.

FIG. 3A illustrates the image block of FIG. 2A with pixels decimated according to a checkerboard pattern of original pixels.

FIG. 3B shows the interpolation of decimated pixels in FIG. 3A to restore the chroma subsampling format of FIG. 2A, with the pixels having an error with respect to the source of FIG. 2A shown with hatching.

### DETAILED DESCRIPTION

In the following description, an embodiment of the invention is described in which the color space format YCbCr is used having a 4:2:2 compression. In this case, each original source pixel has its luminance or brightness value specified in the source, however even Cb and Cr pixels are left out. When converting such an image to a RGB display signal, the even Cb and Cr pixels are either repeated from the previous odd values or interpolated from other odd Cb and Cr pixels, and even R, G and B values use the individual luminance values for the even pixels. When generating a YCbCr display output, the even Cb and Cr pixels missing from the source are interpolated, again either by simple repeating or by spatial interpolation. It will be appreciated that the invention can be applied to different chroma subsampling formats.

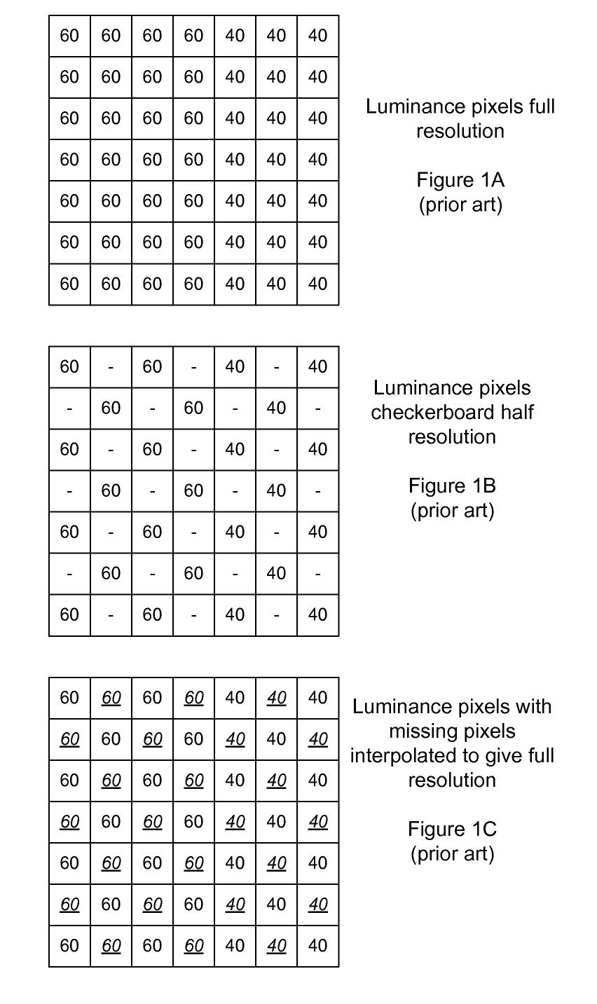

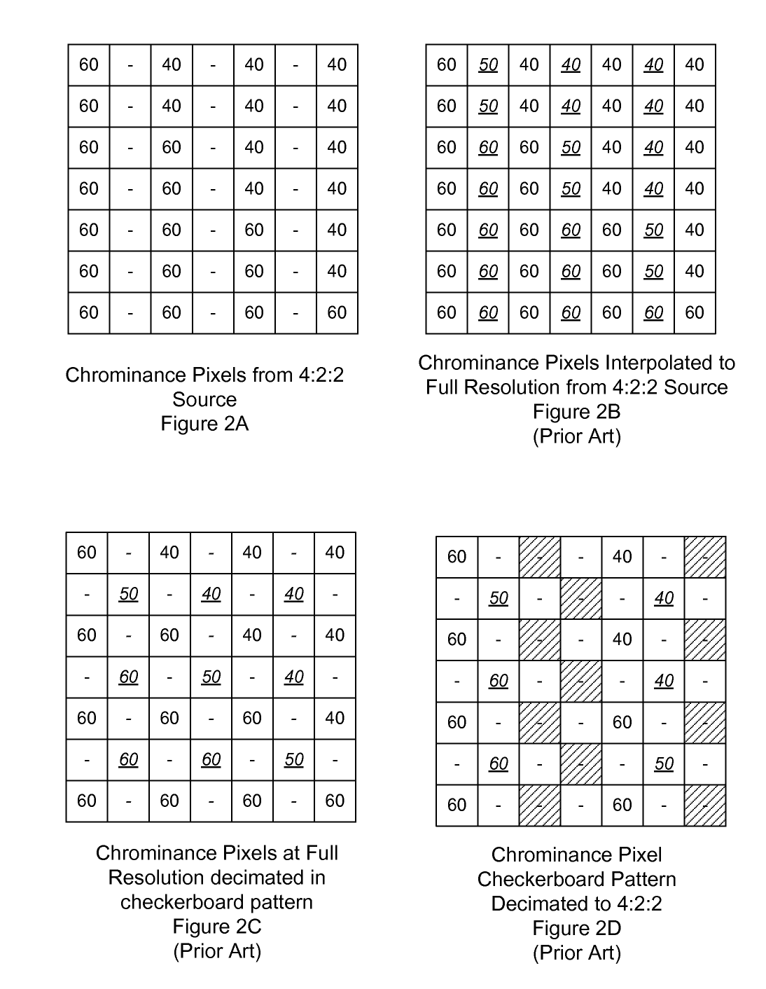

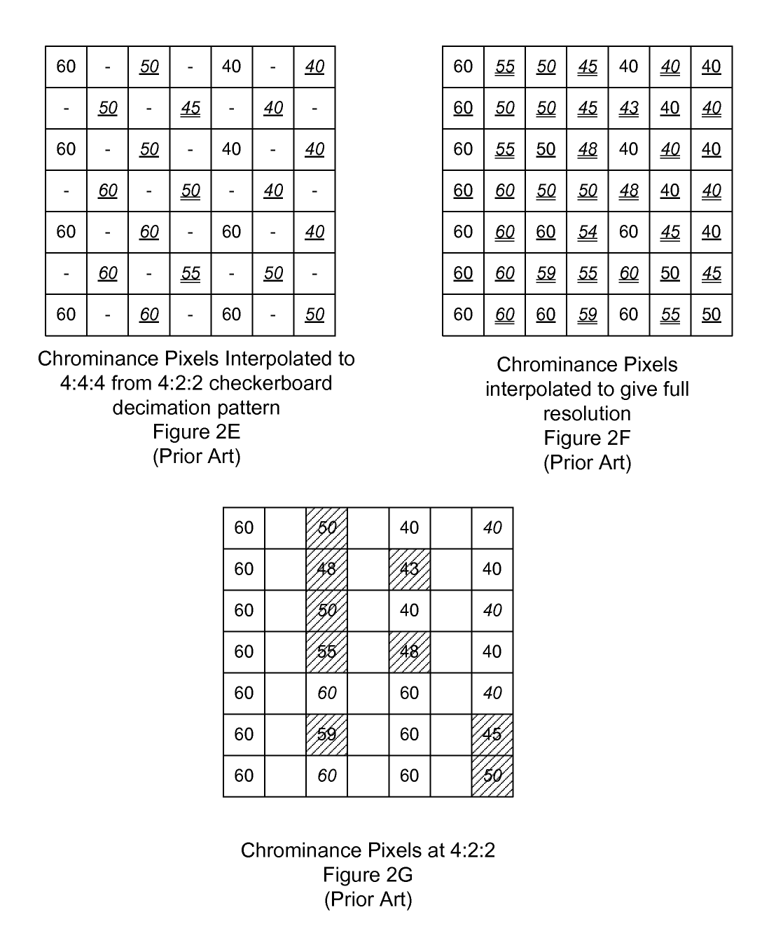

In FIG. 2B, the source chroma component of the YCbCr image of FIG. 2A has been restored to have both even and odd chroma pixels. To encode this image using a checkerboard pattern used for the luminance pixels in FIG. 1B, pixels within the checkerboard pattern are retained and remaining pixels are decimated. As shown in FIG. 2C, the odd lines comprise original Cb and Cr pixels, while the even lines comprise only interpolated Cb and Cr pixels (interpolated pixels are shown with underlined values). In keeping with the 4:2:2 format, the encoded image contains twice as many luminance pixels as chrominance pixels, and thus one half of the retained chrominance pixels are decimated as shown in FIG. 2D to provide the pixels for encoding. These chroma pixels can be rearranged in a side by side or above-below concatenated frame format for storing stereoscopic right eye and left eye image pairs within a single monoscopic video data frame chroma channel.

When this encoded image of FIG. 2D is restored (i.e. decoded) into the original 4:4:4 checkerboard pattern (FIG. 2E) and missing pixels are interpolated (FIG. 2F), the chroma pixels of even lines comprise odd pixels that are based on interpolated pixels of interpolated pixels (shown as double underlined), and even pixels that are based on interpolated original pixels. The pixels shown as double underlined are interpolated based on neighboring pixels that themselves have interpolated values from original pixels. In comparison with odd lines in which the odd chroma pixels are original and the even chroma pixels are interpolated from original pixels, there is a significant difference for chroma pixels between odd and even lines. This difference results, in most cases, in a noticeable image artefact.

In some cases the desired output will also be in 4:2:2, and FIG. 2G shows the image block of chroma pixels in 4:2:2. The shaded pixels are the ones that have errors with respect to the original pixels of FIG. 2A.

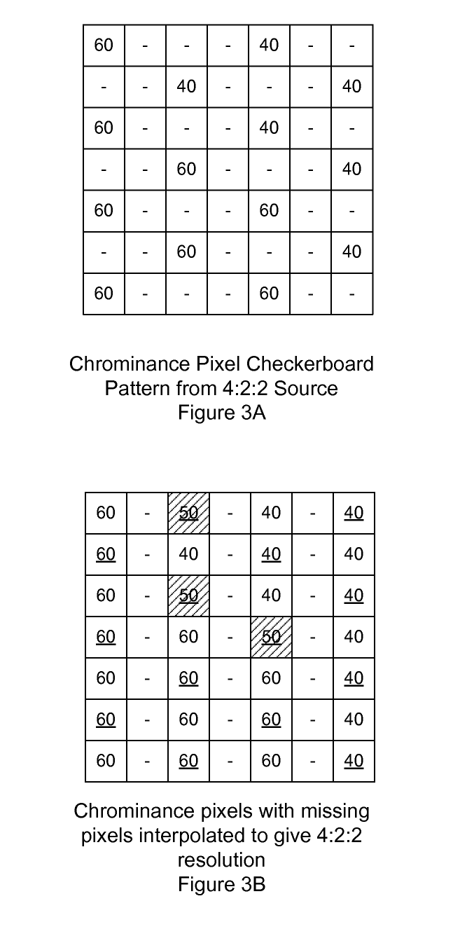

In FIG. 3A, the image block of FIG. 2A is decimated using a checkboard pattern of source chroma pixels. If this operation is done on a source YCbCr image that has been restored to have both even and odd Cb and Cr pixels as in FIG. 2B, the source pixels are used in the pattern. It will be appreciated that it is not necessary to interpolate the missing chroma pixels in this embodiment. To encode this image using a checkerboard pattern, luminance pixels within a first checkerboard pattern (the same as in the FIG. 1B) are retained and remaining pixels are decimated. A different checkerboard pattern is used for the chrominance pixels. The chroma checkerboard pattern is based on original chroma pixels, without containing interpolated chroma pixels.

As shown in FIG. 3A, the odd lines comprise original Cb and Cr pixels from the same pixel location as the luminance pixels of the odd lines, while the even lines comprise original chroma pixels neighboring the luminance pixels of the even lines. Since the chrominance checkerboard pattern is already at half the resolution of the luminance checkerboard pattern, the retained pixels do not need further decimation to respect the 4:2:2 format.

These chroma pixels of FIG. 3A can be rearranged in a side by side or above-below concatenated frame format for storing stereoscopic right eye and left eye image pairs within a single monoscopic video data frame chroma channel. When this encoded image is restored or decoded into the original checkerboard pattern and missing pixels are interpolated, the chroma pixels are either original pixels or interpolated from original pixels. There is essentially no apparent difference between even and odd lines in the decoded image of this embodiment.

The interpolation of the missing pixels is more efficient in the case of FIG. 3A than for the case of FIG. 2D since each pixel in FIG. 3A has two immediately adjacent original pixels in the vertical direction and two original pixels in the horizontal direction two columns over. The number of calculations to restore the 4:2:2 image is also reduced in the case of FIG. 3B than for producing FIG. 2G.

In FIG. 3B, the restored chroma image has three pixels in the subsampled image block that have an error with respect to the original image block of FIG. 2A. This is to be compared with FIG. 2G that has nine pixels with errors. Of course every erroneous pixel in the subsampled image block will pass on its error to its neighboring interpolated pixels in the full resolution chroma image block.

It will also be appreciated that when the image of FIG. 3B is restored to resolution, it is possible to calculate accurately each pixel missing in FIG. 3A from direct neighboring original pixels. No pixel need to be calculated from a neighboring pixel value that itself has been interpolated, since sufficient neighboring original pixels are present for an accurate interpolation.

What is claimed is:

1. A method of encoding in a format having a checkerboard pixel decimation pattern chroma subsampled video data having full resolution of source luminance pixels and less resolution of source chrominance pixels, said source chrominance pixels being interpolated to provide non-source chrominance pixels to provide full resolution, the method comprising retaining a first checkerboard pattern of luminance pixels and a second checkerboard pattern of uninterpolated source chrominance pixels.

2. The method of claim 1, wherein said video data is stereoscopic video data, said encoding providing frames of compressed left-eye and right-eye images merged together.

3. The method of claim 2, wherein said frames comprise side-by-side merged images.

4. The method of claim 1, wherein said chroma subsampled video data is 4:2:2 format.

5. A method of decoding video data encoded in a format having a checkerboard pixel decimation pattern chroma subsampled video data having full resolution of source luminance pixels and less resolution of source chrominance pixels, said source chrominance pixels being interpolated to provide non-source chrominance pixels to provide full resolution, the method comprising interpolating decimated pixels of a first checkerboard pattern of luminance pixels and interpolating decimated pixels of a second checkerboard pattern of uninterpolated source chrominance pixels to restore said chroma subsampled video data.

6. The method of claim 5, wherein said video data is stereoscopic video data, said encoding providing frames of compressed left-eye and right-eye images merged together.

7. The method of claim 6, wherein said frames comprise side-by-side merged images.

8. The method of claim 5, wherein said chroma subsampled video data is 4:2:2 format.
